(19) United States
(12) Patent Application Publication
(10) Pub. No.: US 2008/0032766 A1
(43) Pub. Date: Feb. 7, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/582,413

(22) Filed: Oct. 18, 2006

Related U.S. Application Data
(60) Provisional application No. 60/831,443, filed on Jul. 18, 2006.

(51) Int. Cl. A63F 13/00

(52) U.S. Cl. 463/20

(57) ABSTRACT

If a combination of symbols re-arranged in a unit game during execution of a base game is a predetermined combination, transition to a second game is executed and a winning combination for a second game is displayed by a display device. Subsequently, in the second game, a player pushes a stop switch to stop the symbols and an award is paid out depending on the number of times for which a symbol winning combination stops on a payline. Therefore, it surely makes the player have expectation of transition to a new game, and prevents the player from losing interest and concern for the game.

### CROSS-REFERENCE TO RELATED APPLICATIONS

This application is based upon and claims the benefit of U.S. Provisional Application No. 60/831,443 (filed Jul. 18, 2006); the entire contents of which are incorporated herein by reference.

### BACKGROUND OF THE INVENTION

1. Field of the Invention

The present invention relates to a slot machine and a method for playing with using playing media such as coins and bills to execute a game.

2. Description of the Related Art

A prior slot machine, as disclosed in U.S. Pat. No. 6,960,133B1 or 6,012,983, scrolls a plurality of symbols on a display provided at a front face of a chassis, and then automatically stops the symbols, when a player inserts playing media such as coins or bills through an insertion slot of the slot machine and inputs a spin-button. Then a random number is generated and symbols to be re-arranged is determined by the generated random number at a time of start of scrolling the symbols as prompted by the input of the spin-button, and, if a combination of the re-arranged symbols is a state of display correspondent to a predetermined mystery bonus, payout of medals correspondent thereto is executed, and, if it is a state to transit to a second game, transition from a base game to the second game and then the second game are executed.

Further, the slot machine is configured to pay out an award on the basis of an award state generated in the progress of the game.

Such a prior slot machine merely automatically stops the symbols scrolled, emergence of a slot machine having new entertainment is desired.

### SUMMARY OF THE INVENTION

A first aspect of the present invention is a slot machine provided with a controller operable to receive a control input signal from an external to cause transition to a second game of a predetermined number of times, in which re-arrangement of a plurality of symbols is enabled, and to regulate payout to vary depending on a number of times for which a result of re-arranging the symbols by the control input signal corresponds with a specific combination of symbols for the second game, if a combination of symbols re-arranged in a first game is a specific combination as a result of re-arranging the symbols arranged on the display.

A second aspect of the present invention is a slot machine provided with a controller operable to re-arrange a plurality of symbols arranged on a display in a first game, wherein the controller transits from a first game in which re-arrangement of the symbols is automatically completed to a second game of a predetermined number of times, in which re-arrangement of a plurality of symbols is enabled by receiving a control input signal from an external, displays a specific combination of symbols for the second game, and regulates payout to vary depending on a number of times for which a result of re-arranging the symbols by the control input signal corresponds with the specific combination of symbols for the second game.

A third aspect of the present invention is a slot machine provided with a display operable to arrange a symbol matrix formed of a plurality of columns and a plurality of rows; a first controller operable to execute a first game to select and determine symbols from a plurality of symbols to be arranged in the symbol matrix and automatically stop the determined symbols from a scroll state so as to re-arrange the symbols as a new symbol matrix; a second controller operable to execute a second game of a predetermined number of times to enable a stop switch operable by a player, cause to display enablement of the stop switch, stop scroll to re-arrange the symbol matrix on the display in relation to timing of input by the player, and regulate payout to vary depending on a number of times for which a result of re-arranging the symbols by the control input signal corresponds with a specific combination of symbols for the second game, if a combination of symbols arranged on a payline set with respect to the symbol matrix re-arranged by the first controller in the first game is a specific combination; and a display device operable to display the specific combination for the second game by a display control of the second control, if the re-arranged combination of the symbols in the first game is a predetermined combination of symbols.

A fourth aspect of the present invention is a playing method of a slot machine, reciprocating a unit game to re-arrange a plurality of symbols to be a combination of symbols determined by a controller from a state of arranging the plurality of symbols on a display, wherein, if the combination of the symbols determined by the controller in a first game to automatically re-arrange the symbols is a predetermined combination, transition to the second game of a predetermined number of times to re-arrange the symbols by operation of the player is executed, and it is enabled to vary payout depending on a number of times for which a result of re-arranging the symbols by operation of the player corresponds with a specific combination of symbols for the second game.

A fifth aspect of the present invention is a playing method executed in a slot machine, re-arranging a plurality of symbols on a display, wherein, if a plurality of symbols arranged on the display is re-arranged, prior to re-arrangement, the controller determines a plurality of symbols for the re-arrangement and re-arranges the plurality of symbols on the display; enabling a stop switch linked with the controller and enabling to re-arrange the plurality of symbols for a predetermined number of times by input of the stop switch independently of control of the controller, if the plurality of the symbols re-arranged are a predetermined combination; and variating payout to the player depending on a number of times for which the specific combination of the symbols is re-arranged by input of the stop switch.

A sixth aspect of the present invention is a playing method executed in a slot machine, reciprocating a unit game in which a game starts by scrolling a plurality of symbols on a display under control of a controller and the game is terminated by being stopped and arranged at a combination of symbols determined by the controller; a first step to make symbols be in a control state capable of re-arranging the symbols for a predetermined number of times, the symbols scrolling on the display on the basis of an input signal from the stop button switch linked with the controller, if symbols to be a predetermined combination are arranged on the display; a second step to judge whether a combination of the symbols re-arranged on the basis of the input signal from the stop button switch becomes a specific combination of symbols in the control state; and a third step to regulate payout depending on a number of times for which a result of judging in the second step is judged to be the specific combination.

Meanwhile, the aforementioned stop switch may be a mechanical button switch or a switch such as a touch screen, and any switch operable from the external by a player to make an opportunity to generate an input signal may be properly applied thereto.

### BRIEF DESCRIPTION OF THE DRAWINGS

FIG. 1 is a flowchart showing a playing method of a slot machine in accordance with an embodiment of the present invention.

FIG. 2 is a perspective view showing the exterior of the slot machine in accordance with the embodiment of the present invention.

FIG. 3 is a drawing showing symbols and code numbers for the respective symbols, which are displayed in a display window provided in the slot machine in accordance with the embodiment of the present invention.

FIG. 4 is a block diagram showing a control circuit of the slot machine in accordance with the embodiment of the present invention.

FIG. 5 is a flowchart showing a procedure of processing authentication and read-out of a game program and a game system program by a motherboard and a gaming board in the slot machine in accordance with the embodiment of the present invention.

FIG. 6 is a flowchart showing a procedure of a base game executed in the slot machine in accordance with the embodiment of the present invention.

FIG. 7 is a flowchart showing a procedure of a second game executed in the slot machine in accordance with the embodiment of the present invention.

FIGS. 8A, 8B are explanatory drawings showing display examples in the display window of the slot machine in accordance with the embodiment of the present invention.

FIG. 9 is an explanatory drawing showing a display example reporting execution of a stop control game in the slot machine in accordance with the embodiment of the present invention.

FIG. 10 is a table showing a correspondence relation between the number of winning combinations re-arranged in the second game and an award to be paid out.

### DETAILED DESCRIPTION OF THE INVENTION

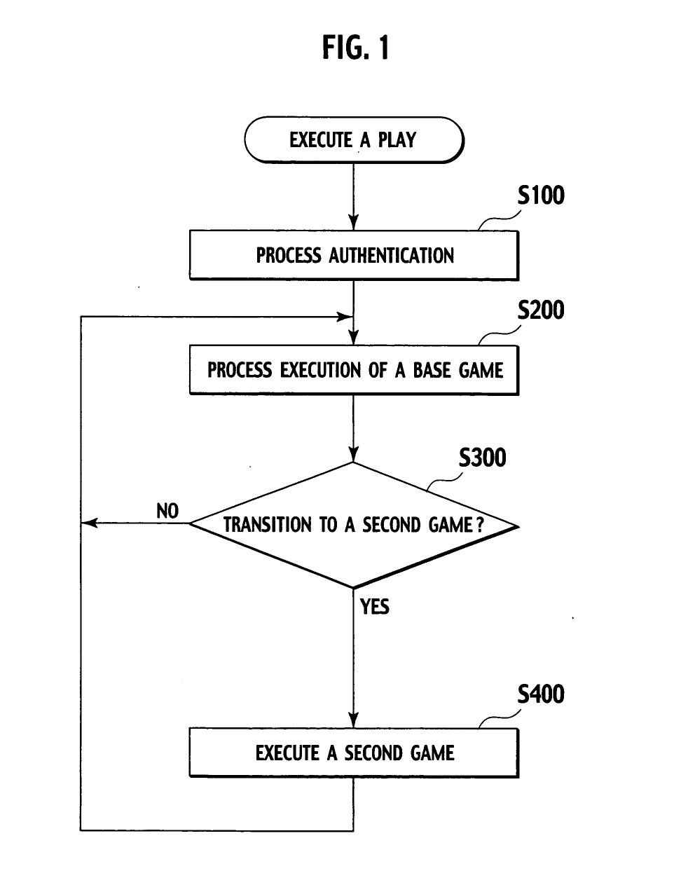

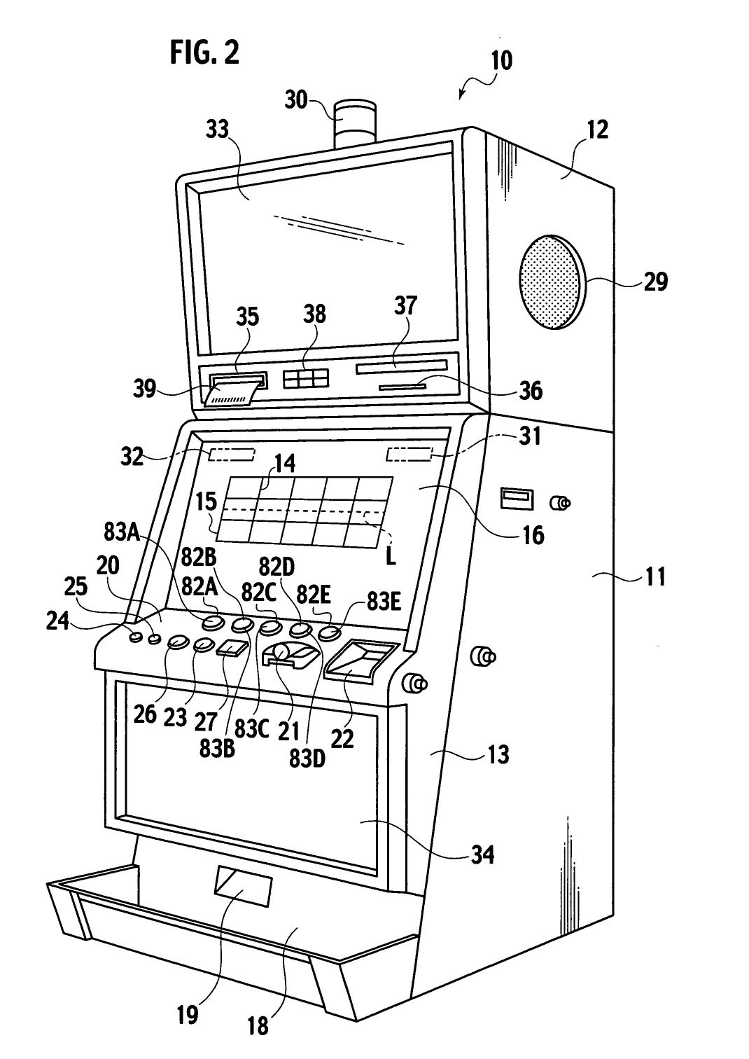

FIG. 1 is a flowchart schematically illustrating a method for playing a slot machine in accordance with the present invention. A schematic operation of the slot machine and the method for playing in accordance with the present invention will be described hereinafter with reference to the flowchart shown in FIG. 1 and the perspective view shown in FIG. 2.

The slot machine in accordance with the present invention executes an authentication process (step S100) when the slot machine is started by turning on the power. Primary ensuring processes, such as ensuring whether the program for operation of the system is normally operable and whether the program is altered, as a former stage before starting unit games are executed in the authentication process.

Next, a base game (first game) based on a basic program (first program) is executed (step S200). In the base game, when a spin button 23 is pushed in a state where a desired number of credits are bet by inserting coins through a coin reception slot 21, symbols to which a video reel method is applied start to be scrolled and then stopped to execute the unit games. In the respective unit games, a stop symbol determination process for determining a combination of symbols automatically stopped and a determination process for determining symbols to be a winning combination in the second game and the stop enabling number of times of the symbols.

Next, whether transition to the second game is executed is judged (step S300) by judging whether a combination of symbols automatically stopped by the stop symbol determination process is a stop combination of symbols (a combination of symbols to trigger the second game: a specific combination) of the second game to transit to the second game (second game) based on the second game program (second program). If the transition to the second game is not executed (NO at the step S300), transition to the next unit game is executed. Meanwhile, in a case where symbols to be a winning combination accompanied by payout stop, after payout of a predetermined number of coins, transition to the next unit game is executed.

Further, in a case where transition to the second game is executed (YES at the step S300), the symbols are automatically stopped at the symbols (a combination of symbols to trigger the second game: a specific combination) of the second game determined by the stop symbol determination process and the second game (second game) composed of a stop control game based on the second program (second program) is reciprocally executed for a predetermined number of times (in this case, ten times) (step S400). The stop control game is a game in which symbols under scroll are stopped when stop switches 82 (see FIG. 2) are pushed by a player.

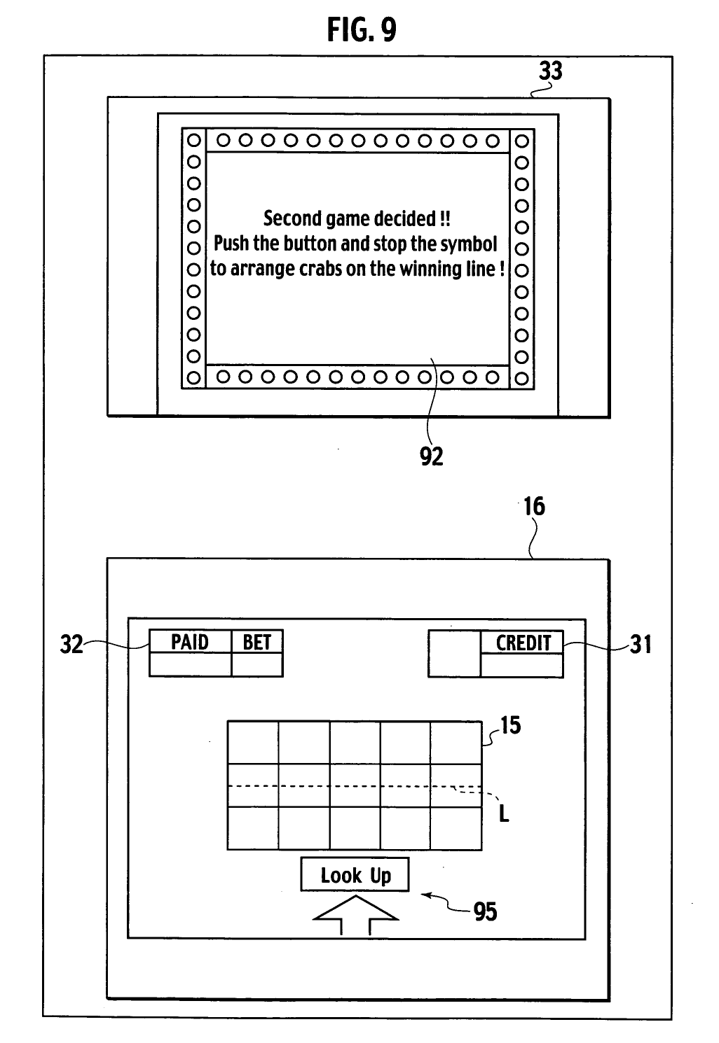

Here, a decision of the second game and a winning combination (arrange crabs in the payline: a specific combination) is displayed as shown in FIG. 9 and the stop switch for stopping the symbols under scroll is to be lit as described later so as to report transition from the base game to the second game (second game) composed of the stop control game to the player.

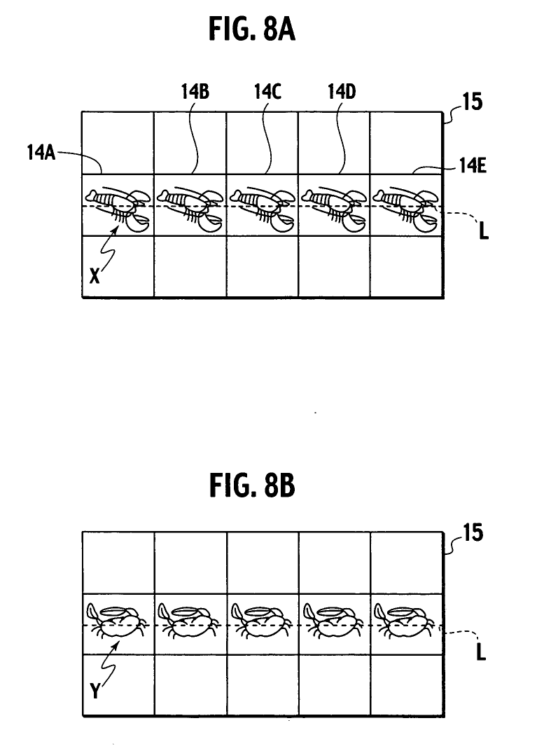

Meanwhile, the stop combination of symbols (the combination of symbols to trigger the second game: a specific combination) of the second game is made to be a case in that five symbols X of lobsters are arranged in a row as shown in FIG. 8A. More specifically, a case in which the symbols of the lobsters stop in respective five variable display parts 14 (14A, 14B, 14C, 14D, 14E) on a payline L of fifteen variable display parts 14 in the display window 15 of the video reel comes to be the stop combination of the symbols (the combination of symbols to trigger the second game: the specific combination) of the second game.

This stop control game is constituted so that the player pushes the lighted stop switch 82 to stop the symbols under scroll at display positions of the display window 15 of the video reel method visible to the player to be a winning combination accompanied by payout. This winning combination (a specific combination) is processed to be determined in execution of the base game (first game) at the step S200, and, for example as shown in FIG. 8B, is to stop the symbols to arrange five symbols Y of crabs in a row as a winning combination on the payline L.

And, in the stop control game, it becomes in a state that, if the player pushes the stop switch 82 so as to arrange a winning combination, a combination of the symbols is made possible to be a winning combination in which five symbols of crabs are arranged as shown in FIG. 8B.

In brief, in a case where the symbol of the crab under scroll is just at the position of the display window 15 (on the payline L), or the symbol of the crab is at the neighbor position in the upper side of the display window 15 when the player pushes the stop switch 82, the symbol of the crab stops on the payline L. Or, in a case where the symbol of the crab does not exist at the aforementioned positions, the symbol of the crab does not stop on the payline L.

As described above, in a case where the stop control game is executed, the symbols under scroll (two on the left) can be made to stop by a stop operation of the stop switch 93 by the player in the second game (second game). Further, in a case where the five symbols of the crabs stop to be arranged in a row on the payline L by stopping the symbols of the crabs, the symbols come to be a winning combination (a specific combination), and transition to the next stop control game is executed and the predetermined number (ten times) of stop control games are executed, and, after the predetermined number (ten times) of stop control games are executed, payout of a predetermined number of coins correspondent to the number of times of completion of winning combination in which five symbols of crabs are arranged in a row are executed.

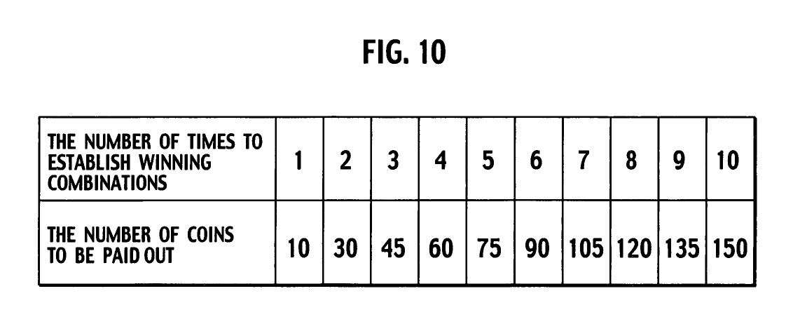

Here, the payout of the coins are determined on the basis of a table shown in FIG. 10 in accordance with the number of times for which the winning combination in which five symbols of crabs are arranged and stop is arranged in a row. For example, after ten times of the stop control games, if the number of times for which the winning combination in which five symbols of crabs are arranged and stop is one, payout of ten coins is executed, and, if the number is five, payout of 75 coins is executed, and, if for all ten times the winning combination is arranged in the row, payout of 150 coins is executed. Moreover, if the winning combination is completed for merely five times among ten as the stop enabling number of times, fifty coins are paid out and not obtained fifty coins for five times are added as a jack pot value.

Meanwhile, it may be modified so that only two symbols are scrolled and stopped by stop operation of the stop switch 82.

Further, the aforementioned example is described for the case in which the five stop switches 82A, 82B, 82C, 82D, 82E (see FIG. 2) are operated to arrange the five symbols, however, it may be modified so that the other numbers of stop switches, for example three stop switches are operated to arrange three symbols or one stop switch is operated to arrange one symbol. Or, it may be constituted so that one stop switch is operated to arrange five symbols step by step.

Further, the present invention is not limited to this embodiment to which a video reel method is applied but can be applied to a slot machine to which a mechanical reel is applied. Moreover, in the above example, in the unit games, the example is illustrated for a case in which the video reel method is applied to scroll and stop symbols in the display window 15 in the unit games, however, it could be modified so that, for example, images of symbols are displayed in the display window 15 and the images of the symbols arranged in the display window 15 are changed to the other images of symbols to be displayed (re-arranged).

Next, a slot machine 10 in accordance with an embodiment of the present invention will be described hereinafter with reference to the perspective drawing shows in FIG. 2. The slot machine 10 is set up in a gaming arcade.

For the slot machine 10, coins, bills or any electronic valuable information correspondent to them are used as playing media for executing the unit games. However, in the present invention, as the playing media, any limitations are not applied, and for example medals, tokens, electronic money and tickets can be exemplified. Meanwhile, as the above tickets, particular limitations are not applied, and for example tickets with bar codes as mentioned later may be exemplified. Meanwhile, in the present embodiment, coins are described as the playing media.

As shown in FIG. 2, the slot machine 10 is provided with a cabinet (chassis) 11, a top box 12 set up on the upper side of the cabinet 11, and a main door 13 provided at a front face of the cabinet 11. A video reel method by which various symbols are shown to stop and scroll is applied so as to show five reels on which various symbols are drawn as if rolling and stop through a display window 15 of a lower image display panel 16 of the cabinet 11.

It is configured so that twenty-two of symbols are respectively displayed in respective variable display parts 14 in the display window 15.

More specifically, fifteen variable display parts 14 display a matrix formed of a plurality of columns and a plurality of rows. Meanwhile, in the present embodiment, an example in which the video reel method is used as a display is exemplified, however, it is modified so that the symbols are made to be scrolled by the mechanical reel method.

Moreover, the lower image display panel 16 is provided with a transparent liquid crystal panel and displays a variety of information and dramatic images with respect to the game in the course of playing the game.

The lower image display panel 16 is provided with the display window 15, a credit number display portion 31, and a payout number display portion 32. In the credit number display portion 31, the number of credited coins is displayed by an image. In the payout number display portion 32, the number of coins to be paid out in a case where a combination of symbols stopping on a payline as described later is a winning combination is displayed by an image.

In the lower image display panel 16, the display window 15 through which a rear face thereof is visible is formed, and symbols are respectively displayed in fifteen variable display parts 14 via the display window 15. On the lower image display pane 116, one payline L is formed to horizontally cross the fifteen variable display parts 14. The payline L regulates combinations of symbols. In a case where a combination of symbols stopping on the payline L is a winning combination, the number of coins depending on the combination of the symbols and the number of bet coins (BET number) will be paid out.

Meanwhile, in the present embodiment, an example in which one payline L is set to horizontally cross will be described, however, for example, it may be modified so that a payline L or such is formed to obliquely cross the fifteen variable display parts 14, a number of paylines L correspondent to the number of inserted coins are enabled, and, in a case where a combination of symbols stopping on the enabled paylines L is a winning combination, the number of coins correspondent to the combination are paid out.

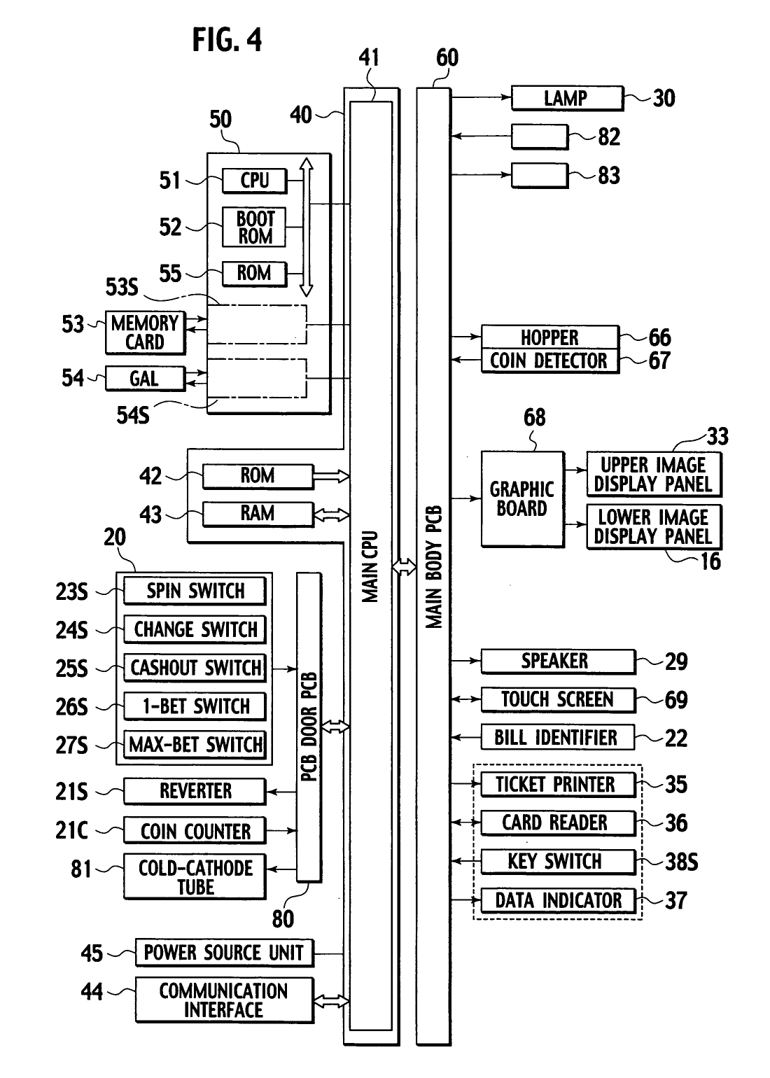

Further, on a front face of the lower image display panel 16, a touch screen 69 (see FIG. 4) is provided, therefore the player may input various instructions by operating the touch screen 69.

Below the lower image display panel 16, a control panel 20 composed of a plurality of buttons 23-27 to which instructions regarding progress of the game are inputted by the player, five stop switches 82 (82A, 82B, 82C, 82D, 82E), a coin reception slot 21, and a bill identifier 22 are provided.

These five stop switches 82 (82A, 82B, 82C, 82D, 82E) are respectively provided with indicator lamps 83 (83A, 83B, 83C, 83D, 83E) as indicator devices for reporting transition from the base game to the second game (second game) composed of the stop control game to the player at portions thereof where the player pushes, and these indicator lamps 83 (83A, 83B, 83C, 83D, 83E) are constituted to be lit in a case where transition from the base game to the second game (second game) composed of the stop control game is executed. Meanwhile, in the present embodiment, merely two indicator lamps 83D, 83E on the left are lit. Or, lighting the indicator lamps 83 (83A, 83B, 83C, 83D, 83E) may be intermittent lighting.

In the present embodiment, the constitution was such that mechanical stop switches 82 are provided correspondently to the respective five variable display parts 14 on the payline L, however, any other constitution may be applied.

More specifically, as a modified example, a constitution may be such that, to arrange a transparent touch screen forward to the display window 15, the touch screen is in place of the stop switches 82 and the interiors of the variable display parts 14 under scroll are displayed to be brighter to prompt the player to touch the variable display parts 14 and hence transition from the base game to the second game (second game) composed of the stop control game is reported.

To such the touch screen, a touch screen applicable to mobile terminals or ATMs in banks can be applied. As such, to dispose the touch screen as the stop switches 82 in front of the display window 15, the player is allowed to make instructions for re-arrangement by touching the symbols to be stopped (re-arranged) via the display window with viewing states of changing the symbols to be scrolled. Such a re-arrangement operation provides an advantage with which the player can carry out the operation with a feeling of direct touch on the symbols.

Further, as described above, the number of the stop switches 82 is not limited to five but allowed to be three or one.

Further, in accordance with the present embodiment, it was constituted such that mechanical stop switches 82 are provided correspondently to the respective five variable display parts 14 on the payline L, however, it was not limited thereto, and it may be constituted such that one stop switch 82 which contributes re-arrangement of merely one variable display part 14 is provided. Thereby, it is made possible that a form of playing in which the player participates in re-arrangement of all (five in this embodiment) the variable display parts 14 by input via the stop switches is changed into a form of playing in which the player participates in re-arrangement of merely one variable display part.

The control panel 20 is provided with a spin button 23, a change button 24, a cash-out button 25, a 1-BET button 26, and a MAX-BET button 27. The spin button 23 is a button for inputting instructions to start the symbols to be scrolled. The change button 24 is a button for inputting instructions to request money changing for a clerk of the gaming arcade. The cash-out button 25 is a button for inputting instructions to make the credited coins paid out to a coin tray 18.

The 1-BET button 26 is a button for inputting instructions to bet one coin on the game. The MAX-BET button 27 is a button for inputting instructions to bet a maximum number of coins (for example, fifty) capable of being bet on one game among the credited coins on the game.

The stop switches 82 (82A, 82B, 82C, 82D, 82E) are switches enabled when the stop control game starts for operation of stopping the symbols under scroll. Further, the respective stop switches 82 (82A, 82B, 82C, 82D, 82E) are respectively provided with the indicator lamps 83 (83A, 83B, 83C, 83D, 83E) and, as described later, in a case where operation of the stop switches 82 (82A, 82B, 82C, 82D, 82E) is enabled, the indicator lamps 83 (83A, 83B, 83C, 83D, 83E) are lit to report enablement of operation of the stop switches 82 (82A, 82B, 82C, 82D, 82E) to the player. Thereby, it report transition from the base game to the second game (second game) composed of the stop control game to the player. Meanwhile, instead of the stop switches 82, operation levers, a track ball, a touch screen and such may be used.

The bill identifier 22 identifies whether the bill is formal or not and introduces a formal bill into the cabinet 11. The bill identifier 22 may be so constituted to read a ticket with a bar code 39. At a front face of a lower portion of the main door 13, more specifically, below the control panel 20, a belly glass 34 on which characters and such of the slot machine 10 are drawn is provided.

On the front face of the top box 12, an upper image display panel 33 is provided. The upper image display panel 33 is provided with a liquid crystal panel and displays, and, for example, as shown in FIG. 9, decision of the second game and a winning combination (arranging crabs in a row) are displayed therein.

Further, the top box 12 is provided with a speaker 29 for output of sound and voice. Below the upper image display panel 33, a ticket printer 35, a card reader 36, a data display 37, and a key pad 38 are provided. The ticket printer 35 is what prints a bar code in which data such as the number of credits, a date, an identification number of the slot machine 10 and such are coded on the ticket and outputs it as the ticket with the bar code 39. The player may use the ticket with the bar code 39 to play the other slot machines and change the ticket with the bar code 39 with a bill and such by a cashier of the gaming arcade.

The card reader 3 is what reads and writes data from and to SMART CARDs. The SMART CARD is a card which the player carries about and, for example, data for identifying the player and data about a history of games which the player had played are stored therein.

The data display 37 is composed of a fluorescence display and such, and displays, for example, data read by the card reader 36 and data inputted through the key pad 38 by the player. Via the key pad 38, instructions and data regarding issue of the ticket are inputted.

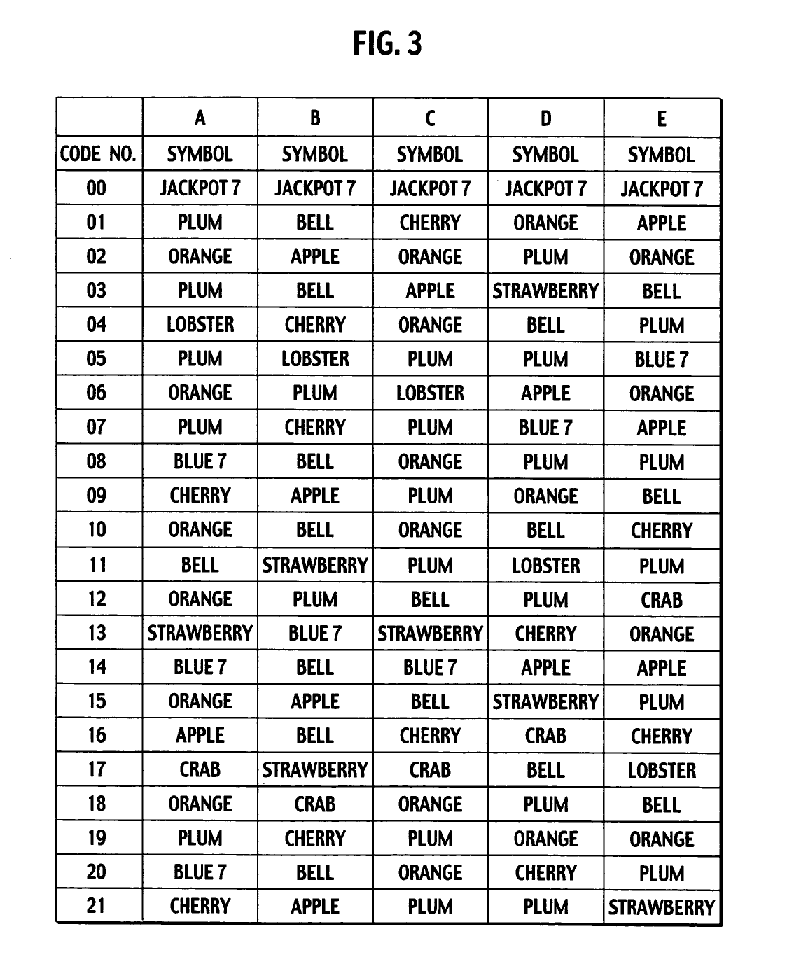

FIG. 3 is an explanatory drawing showing a row of symbols displayed in the display window 15. In the variable display parts 14A, 14B, 14C, 14D, 14E of the display window 15, twenty-two of symbols are displayed in each row.

Here, a state in which the symbols Y of the lobsters respectively stop on the five variable display parts 14 (14A, 14B, 14C, 14D, 14E) on the payline L comes to be a symbol combination to realize a second game trigger (a symbol for transition to the second game) (see FIG. 8A).

Moreover, in the stop control game, a state in which the symbols X of the crabs respectively stop on the five variable display parts 14 (14A, 14B, 14C, 14D, 14E) on the payline L comes to be a winning combination (see FIG. 8B).

The respective symbols start being scrolled if the 1-BET button 26 or the MAX-BET button 27 is pushed and, after this, the spin button 23 is pushed. More specifically, the symbols are scrolled in the display window 15 from the upper direction to the lower direction and stop after the elapse of a predetermined period of time. Then, any of the symbols stops in the display window 15. A game from start until stop of scroll of the respective symbols is the unit game. More specifically, the game from making the symbols arranged with respect to the display scroll until re-disposing them is the unit game.

Further, various winning combinations are predetermined with respect to the respective symbols and, if any symbols to be a winning combination stop on the payline L, the payout number of coins depending on the winning combination are added to the credit which the player has. Moreover, if the second game trigger is realized, more specifically, in the present embodiment, the respective symbols of the lobsters stop on the payline L, the gaming state transits from the base game state to the gaming state of the second game.

FIG. 4 is a block diagram showing a control circuit of the slot machine 10 shown in FIG. 2. As shown in FIG. 4, the control circuit is constituted of a motherboard 40, a main body PCB (Printed Circuit Board) 60, a gaming board 50, a door PCB 80, various switches, sensors and such constitutional elements.

The gaming board 50 is provided with a CPU (Central Processing Unit) 51, a ROM 55, a boot ROM 52, which are interlinked via an internal bus, a card slot 53S supporting the memory card 53, and an IC socket 54S supporting a GAL (Generic Array Logic) 54.

In the memory card 53, a game program and a game system program are stored. The game program includes a stop symbol determination process program. The stop symbol determination process program is a program for determining symbols stopping on the payline L (code numbers correspondent to the symbols). The stop symbol determination process program includes symbol weighted data respectively correspondent to a plurality of kinds of payout rates (for example, 80%, 84%, 88%). The symbol weighted data are data showing relation between the respective code numbers and one or more random numbers belonging to a predetermined number range (0-256) with respect to each of five rows.

The payout rates are what are decided based on data for payout rate decision outputted from the GAL 54, and a stop symbol determination process is carried out on the basis of the symbol weighted data correspondent to the payout rates.

The card slot 53S is constituted such that the memory card 53 is insertable into and removable from it, and is linked with the motherboard 40 via an IDE bus. Accordingly, by removing the memory card 53 from the card slot 53S, writing the other game program and the other game system program on the memory card 53, and inserting the memory card 53 into the card slot 53S, a kind of the game and the contents thereof executed in the slot machine 10 can be changed.

The game program includes a first program for executing a base game as a program relating to progress of the game, a second program for executing a second game, and a program for transition to the second game. Moreover, the game program includes image data and sound data for output in the course of the game. Furthermore, the game program includes image data and sound data as reporting data for reporting enablement of operation to stop the respective symbols by the stop switches 82 when the player is awarded in the second game and the second game trigger is realized to the player.

The GAL 54 is provided with a plurality of input ports and a plurality of output ports, and, when data are input to the input ports, data correspondent to these data are output from the output ports. Data output from the output ports are the aforementioned data for payout rate decision.

Further, the IC socket 54S is constituted such that the GAL 54 is installed and uninstalled thereto and linked with the motherboard 40 via a PCI bus. Accordingly, by uninstalling GAL 54 from the IC socket 54S, rewriting the program stored in the GAL 54, and installing the GAL 54 into the IC socket 54S, the data for payout rate decision output from the GAL 54 can be changed.

The CPU 51, the ROM 55 and the boot ROM 52 interlinked via the internal bus are linked with the motherboard 40 via the PCI bus. The PCI bus transmits signals between the motherboard 40 and the gaming board 50, and supplies electric power from the motherboard 40 to the gaming board 50. In the ROM 55, country identification information and an authentication program are stored. In the boot ROM 52, a reserved authentication program and a program for booting the reserved authentication program by the CPU 54 (boot code) are stored.

The authentication program is a program for authenticating the game program and the game system program (alteration check program). The authentication program is a program for verifying and proving that the game program and the game system program are not altered. More specifically, the authentication program is described in line with a procedure of authenticating the game program and the game system program. The reserved authentication program is a program for authenticating the aforementioned authentication program. The reserved authentication program is described in line with the procedure of proving that the authentication program subject to the authentication process is not altered, namely authenticating the authentication program.

The motherboard 40 is provided with a main CPU 41 (controller), a ROM (Read Only Memory) 42, a RAM (Random Access Memory) 43, and a communication interface 44.

The main CPU 41 has a function as a controller for controlling the whole of the slot machine 10. In particular, the main CPU 41 carries out control of outputting instruction signals for making a motor drive circuit 61 to rotate respective stepping motors 70 when credits are bet and the spin button 23 is pushed, control of determination of symbols to stop at the position of the display window 15 (on the payline L) after the symbols are made in a scroll state, and control of making a plurality of symbols stop at the position of the display window 15. More specifically, the main CPU 41 has a function as an arrangement controller for executing an arrangement control to determine arrangement symbols to a symbol matrix out of a plurality of kinds of symbols and stop the determined symbols from the scroll state so as to re-arrange symbols as a new symbol matrix after scrolling a plurality of symbols displayed on the display.

Further, the main CPU 41 has a function as a stop switch controller of enabling the stop switches 82 only if a combination of symbols arranged on the payline L set for a symbol matrix is determined to be a specific combination, and stopping scroll for executing re-arrangement of the symbol matrix on the display on the basis of control input signals relating to input timing for the stop switches 82 by the player.

In the ROM 42, programs such as a BIOS (Basic Input/Output System) executed by the main CPU 41 and data permanently used are stored. When the BIOS is executed by the main CPU 41, initialization process is done to the respective peripheral devices and process of reading out of the game program and the game system program stored in the memory card via the gaming board 50 is started and they are moved to the RAM 43 and such.

In the RAM 43, data and programs used at a time when the main CPU carries out processes are stored. The RAM 43 has an area to store a variable “n” indicating the number of execution of the stop control game described later.

The communication interface 44 is one for having communication with a host computer and such provided in the gaming arcade via a communication circuit.

Further, to the main CPU 41, a counter 85 for counting the number of times at which the player has stop the symbols at the winning combination is linked.

Further, to the motherboard 40, the main body PCB (Printed Circuit Board) 60 and the door PCB 80 are linked via an USB (Universal Serial Bus). Furthermore, to the motherboard 40, a power source unit 45 is linked. When electric power is supplied from the power source unit 45 to the motherboard 40, the main CPU 41 of the motherboard 40 boots up and the power is further supplied to the gaming board 50 via the PCI bus so that the CPU 51 boots up.

To the main body PCB 60 and the door PCB 80, devices and apparatuses to generate input signals to be inputted into the main CPU 41, and devices and apparatuses controlled by control signals outputted from the main CPU 41, are linked. The main CPU 41 carries out processes of processing calculation, storing results thereof in the RAM 43, transmitting control signals to the respective devices and apparatuses as control processes with respect to the respective devices and apparatuses, by executing the game program and the game system program stored in the RAM 43 on the basis of the input signals inputted to main CPU 41.

To the main PCB 60, a lamp 30, a hopper 66, a coin detector 67, a graphic board 68, the speaker 29, the touch screen 69, the bill identifier 22, the ticket printer 35, the card reader 36, a key switch 38S, and the data display 37 are linked. Furthermore, to the main body PCB 60, the five stop switches 82, and the five indicator lamps 83 provided in correspondent to the respective stop switches 82 are linked.

The lamp 30 is controlled of lighting and lighting-off on the basis of the control signals outputted from the main CPU 41.

The hopper 66 is installed in the cabinet 11 and pays out a predetermined number of coins through the coin payout exit 19 to the coin tray 18 on the basis of the control signals outputted from the main CPU 41. The coin detector 67 is provided in the coin payout exit 19 and outputs output signals to the main CPU 41 in a case where it detects that the predetermined number of coins are paid out through the coin payout exit 19.

The graphic board 68 controls image display on the upper image display panel 33 and the lower image display panel 16 on the basis of the control signals outputted from the main CPU 41. On the credit number display portion 31 of the lower image display panel 16, the number of credits stored in the RAM 43 is displayed. The graphic board 68 is provided with a VDP (Video Display Processor) for generating image data on the basis for the control signals outputted from the main CPU 41 and a video RAM temporarily storing the image data generated by the VDP.

The bill identifier 22 read an image of the bill and introduces a formal bill into the cabinet 11. Further, the bill identifier 22 outputs input signals to the main CPU 41 on the basis of a value of the bill when the formal bill is introduced. The main CPU 41 stores the number of credits in accordance with the value of the bill transmitted by the input signals in the RAM 43.

The ticket printer 35 prints a bar code in which data such as the number of credits, a date, an identification number of the slot machine 10 and such are coded on the ticket and outputs it as the ticket with the bar code 39.

The card reader 36 reads out data from the SMART CARD and transmits the data to the main CPU 41, and further writes data on the SMART CARD on the basis of the control signals from the main CPU 41. The key switch 38S is provided on the key pad 38 and outputs input signals to the main CPU 41 when the key pad 38 is operated by the player.

The data display 37 displays data read out by the card reader 36 and data inputted via the key pad 38 by the player on the basis of the control signals outputted from the main CPU 41.

The stop switches 82 are buttons to stop symbols under scroll when the stop control game is executed as described later. As described later, in a case where transition to the second game is executed, the respective stop switches 82 are enabled and the respective display lamps 83 are lit. Thereby, it reports transition from the base game to the second game (second game) composed of the stop control game to the player. And, the main CPU 41 carries out control of stopping the symbols at a timing of being pushed in a case where the stop switches 82 are pushed by the player.

To the door PCB 80, the control panel 20, a reverter 21S, a coin counter 21C, and a cold-cathode tube 81 are linked. The control panel 20 is provided with a spin switch 23S correspondent to the spin button 23, a change switch 24S correspondent to the change button 24, a cash-out switch 25S correspondent to the cash-out button 25, a 1-BET switch 26S correspondent to the 1-BET button 26, and a MAX-BET switch 27S correspondent to the MAX-BET button 27. The switches 23S-27S output input signals to the main CPU 41 when the correspondent buttons 23-27 are operated by the player.

The coin counter 21C is provided in the interior of the coin reception slot 21, and identifies whether the coin inserted by the player into the coin reception slot 21 is formal or not. Others than formal coins are exhausted from the coin payout exit 19. Further, the coin counter 21C outputs input signals to the main CPU 41 when the formal coins are detected.

The reverter 21S is what functions on the basis of the control signals from the main CPU 41, and distributes coins identified as formal coins by the coin counter 21C to a cash box (not shown) installed in the interior of the slot machine 10 or the hopper 66. More specifically, if the hopper 66 is filled with coins, the formal coins are distributed into the cash box by the reverter 21S. On the other hand, if the hopper 66 is not filled with coins, the formal coins are distributed into the hopper 66.

The cold-cathode tube 81 functions as a back-light installed at the rear face of the lower image display panel 16 and the upper image display panel 33 and is lit on the basis of the control signals outputted from the main CPU 41.

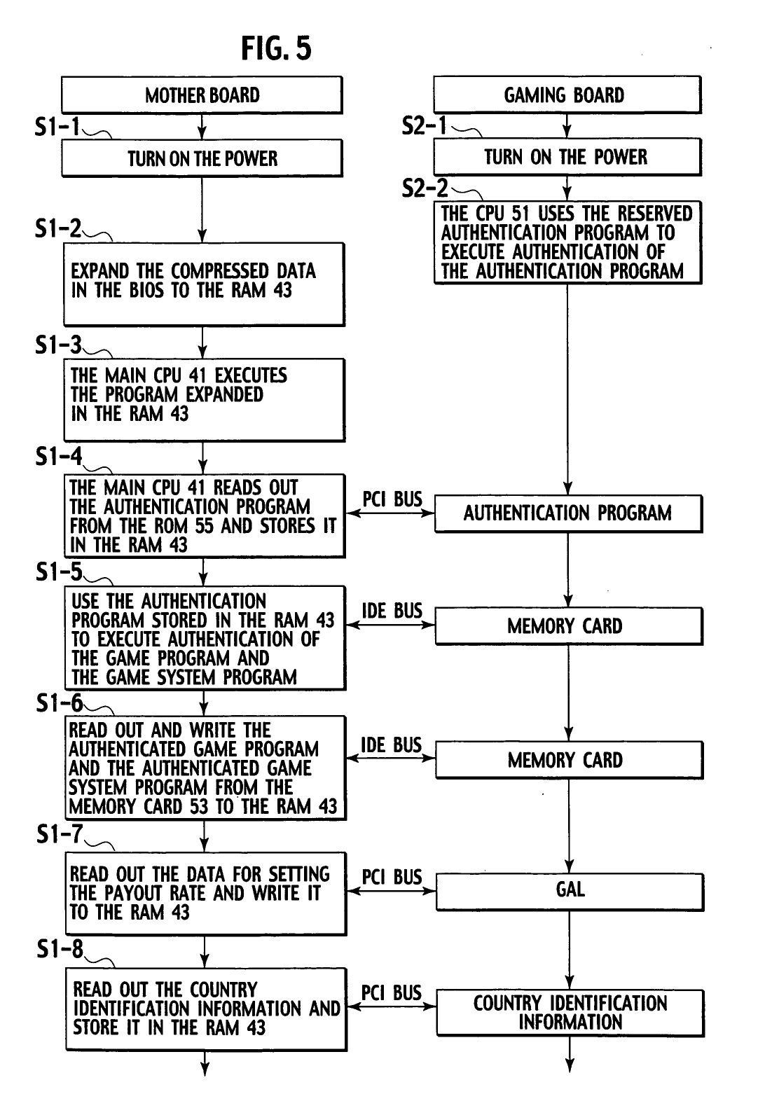

Next, concrete processes executed in the slot machine 10 will be described hereinafter. FIG. 5 is a flowchart showing a procedure of processes (the process of the step S100 shown in FIG. 1) for authentication and read of the game program and the game system program by the motherboard 40 and the gaming board 50 shown in FIG. 4. Meanwhile, it is assumed that, to the card slot 53S in the gaming board 50, the memory card 53 is installed, and, to the IC socket 54S, the GAL 54 is installed.

First, when the power switch is switched on in the power source unit 45, the motherboard 40 and the gaming board 50 boot up (step S1-1, S1-2). When the motherboard 40 and the gaming board 50 boot up, individual processes are carried out in parallel. More specifically, in the gaming board 50, the CPU 51 reads out the reserved authentication program stored in the boot ROM 52 and carries out reserved authentication to verify and prove that the authentication program is not altered in advance before being took in the motherboard 40 on the basis of the read reserved authentication program (step S2-2).

On the other hand, in the motherboard 40, the main CPU 41 executes the BIOS stored in the ROM 42 to expand compressed data integrated in the BIOS to the RAM 43 (step S1-2). And, the main CPU 41 executes the BIOS expanded to the RAM 43 to diagnose and initialize various peripheral devices (step S1-3).

Subsequently, since the ROM 55 of the gaming board 50 is linked to the main CPU 41 via the PCI bus, the main CPU 41 reads out the authentication program stored in the ROM 55. Furthermore, the main CPU 41 carries out processes to store the read authentication program in the RAM 43 (step S1-4).

Next, the main CPU 41 accesses the memory card 53 installed in the card slot 53S via the IDE bus. And, the main CPU 41 reads out the game program and the game system program stored in the memory card 53.

Next, the main CPU 41 carries out authentication to verify and prove that the read game program and game system program are not altered in accordance with the authentication program stored in the RAM 43 (step S1-5).

When the authentication process is normally finished, the main CPU 41 stores the authenticated game program including the first game program and the authenticated game system program in the RAM 43 (step S1-6). Next, the main CPU 41 accesses the GAL 54 installed in the IC socket 54S via the PCI bus, reads out the data for payout rate decision from the GAL 54, and stores it in the RAM 43 (step S1-7). Next, the main CPU 41 reads out the country identification information stored in the ROM 55 of the gaming board 50 via the PCI bus, and stores the read country identification information in the RAM 43 (step S1-8).

After carrying out the aforementioned processes, the main CPU 41 progresses the base game shown as the following by booting, sequentially reading and executing the base game program (first program) stored in the RAM 43. Here, the main CPU 41 functions as a first controller at a time of booting the base game program (first program) stored in the RAM 43 to execute the base game.

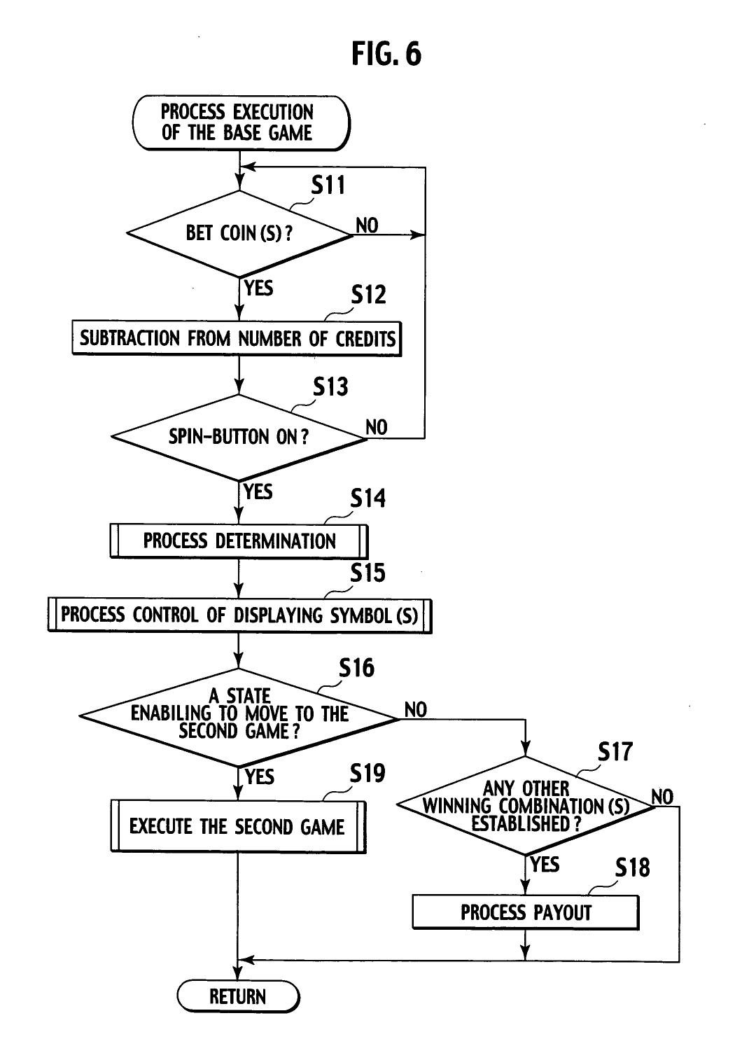

After the reading and authentication process shown in FIG. 5 is finished, the main CPU 41 carries out an execution process for the base game on the basis of the base game program (first program). FIG. 6 is a flowchart showing a concrete process procedure for the base game execution process shown in the step S200 of FIG. 1.

In the base game execution process, first, the main CPU 41 decides whether coins are bet or not (step S11). In this process, the main CPU 41 decide whether the input signals outputted from the 1-BET switch 26S when the 1-BET button 26 is pushed or the input signals outputted from the MAX-BET switch 27S when the MAX-BET button 27 is pushed is received or not. If the coins are decided not to be betted, the process returns to the step S11.

On the other hand, in the step S11, if the coins are decided to be betted, the main CPU 41 processes subtraction from the number of credits stored in the RAM 43 depending on the number of betted coins (step S12). Meanwhile, if the number of betted coins is greater than the number of credits stored in the RAM 43, the process returns to the step S11 without processing subtraction from the number of credits stored in the RAM 43. Moreover, if the number of betted coins exceeds the maximum value (in the present embodiment, fifty) capable of being bet on one game, the process returns to the step S11 without processing subtraction from the number of credits stored in the RAM 43. In this state, the symbols in the display window 15 become a state capable of starting scroll.

Next, the main CPU 41 decides whether the spin button 23 is switched on or not (step S13). In this process, the main CPU 41 decides whether the input signals outputted from the spin switch 23S when the spin button 23 is on.

If the spin button 23 is decided not to be on (for example, a case where an instruction to terminate the game is inputted without switching the spin button 23 on), the main CPU 41 cancels the result of subtraction in the step S12.

In the present embodiment, a case of carrying out a process of subtraction from the number of credits (step S12) after betting the coins (step S11) and before deciding whether the spin button 23 is switched on (step S13) will be described. However, the present invention is not limited to this example. For example, the process of subtraction from the number of credits (step S12) may be carried out in a case where, after betting the coins (step S11), a decision whether the spin button 23 is switched on (step S13) is carried out and the spin button 23 is decided to be switched on (YES at the step S13).

And, in the step S13 of FIG. 6, if the spin button 23 is decided to be switched on, the main CPU 41 carries out a stop symbol determination process (step S14). In this stop symbol determination process, the main CPU 41 executes the stop symbol determination program stored in the RAM 43 to determine symbols to stop on the payline L.

Meanwhile, in the present embodiment, a case of determining one winning combination (see FIG. 8A) from a plurality of winning combinations to transit to the second game by determining a combination of symbols to be stop-displayed will be described, however, in the present invention, for example, one winning combination selected from a plurality of winning combinations is in advance determined by the stop symbol determination process and after this a combination of symbols may be determined on the basis of the aforementioned winning combination.

Next, the main CPU 41 carries out a display control process of the symbols by the lower image display panel 16 (step S15). This process is a process, after starting scroll of symbols of the whole row, to stop the scroll of the symbols so that arrangement of symbols correspondent to the winning combination determined in the step S14 stops on the payline L.

Next, the main CPU 41 refers to a table or such regulating the winning combinations to decide whether the symbols stopping on the payline L are the winning combination (see FIG. 8A) or not and decides whether it becomes a transition enablement state to the second game or not (step S16).

If the transition enablement state is not realized (NO at the step S16), the main CPU refers to a table or such regulating the winning combinations to decide whether the symbols fulfilling another winning combination stop or not (step S17). If the symbols fulfilling another winning combination are decided to stop, the main CPU 41 carries out payout of coins depending on the number of inserted coins and the winning combination (step S18). In a case where the coins to be paid out are pooled, the main CPU 41 adds a predetermined number of coins to the number of credits stored in the RAM 43. Moreover, in a case where the coins are paid out, the main CPU 41 transmits control signals to the hopper 66 to pay out a predetermined number of coins. Then, the coin detector 46 counts the number of coins paid out from the hopper 66 and, when the counted number reaches a designated number, transmits payout completion signals to the main CPU 41. Thereby, the main CPU 41 stops to drive the hopper 66 and terminates payout of the coins.

Further, at the step S17, if any of the winning combinations are decided not to be realized (decided to be a failure) or the process of the step S18 is carried out, the process is terminated.

On the other hand, at the step S16, in a case where it is in the transition enablement state to the second game, the main CPU 41 boots up the second game program (second program) stored in the RAM 43 to execute the second game (step S19; step S400 shown in FIG. 1).

Here, the main CPU 41 functions as a second controller at a time of booting the second game program (second program) stored in the RAM 43 to execute the second game.

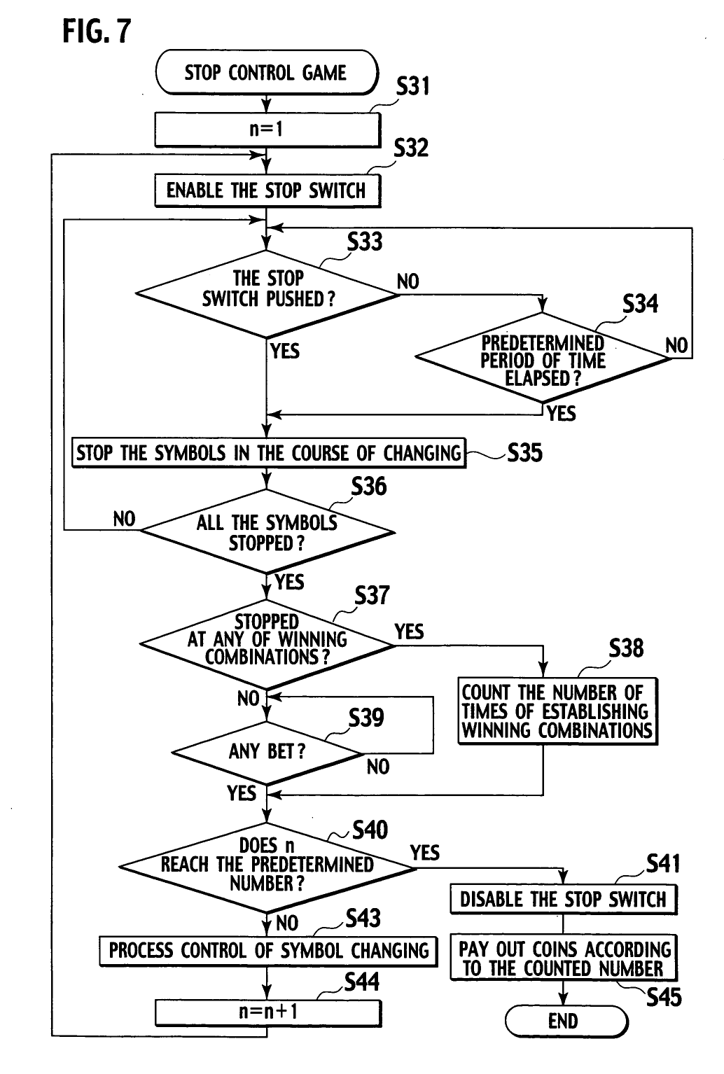

FIG. 7 is a flowchart showing a procedure of a process of the stop control game as the second game.

In the stop control game, first the variable “n” indicating the number of execution of the stop control game is set to be 1 (step S31). The value of the variable “n” is stored in the RAM 43. Next, the symbols in the display window 15 is made to be scrolled and the five stop switches 82 shown in FIG. 2 are enabled (step S32). More specifically, by pushing the five stop switches 82, the five symbols under scroll are set to be a state capable of stop.

Then, to report that the stop switches 82 are operable and a winning combination is crabs to the player, as shown in FIG. 9, letters of “SECOND GAME DECIDED!! PUSH THE BUTTON AND STOP THE SYMBOL TO ARRANGE CRABS ON THE WINNING LINE!” are displayed in the upper image display panel 33 of the slot machine 10. Further, the main CPU 41 carries out control of lighting the display lamps 83 of the stop switches 82. Thereby, the player is informed of transition from the base game to the second game (second game) composed of the stop control game. Meanwhile, lighting of the display lamps 83 may be intermissive lighting as mentioned above.

Next, the main CPU 41 decides whether the stop switches 82 are pushed or not (step S33). If the stop switches 82 are pushed, the main CPU 41 stops the symbols in the row correspondent to the pushed stop switches 82 (step S35).

In this case, the main CPU 41 controls stop positions of the symbols in the respective rows so as to stop symbols of five crabs as a winning combination to be arranged in a row on the payline L provided at a display position of the display window 15 as shown in FIG. 8B. More specifically, the scrolled symbols are made in a state capable of being re-arranged as a specific combination.

More specifically, in the present embodiment, symbols of variable display parts 14 on the display window 15 are made to be scrolled and it becomes a state enabling that they can become a winning combination by arranging five symbols of crabs in a row by pushing the stop switches 82. In this case, the display lamps 83 of the stop switches 82 are to be lit.

Further, in a case where the stop switches 82 are not pushed after the elapse of a predetermined period of time (a time limit) (YES at the step S34), a state is made in which the stop switches 82 are disabled so as not to transmit control input signals to the main CPU 41 if being pushed, and the symbols are automatically stopped (step S35).

Next, the main CPU 41 decides whether symbols in all the rows are stopped or not (step S36). Then, if the symbols in all the rows are not stopped, the process returns to the step S33. If the symbols in all the rows are stopped, the main CPU 41 decides whether the stopped symbols are a winning combination (a specific combination) in which five symbols of crabs are arranged in a row or not (step S37).

And, if five symbols of crabs stop to be arranged on the winning line L by stopping the symbols of the crabs, it becomes the winning combination (a specific combination) and the number of times to be the winning combination is counted by the counter 85. More specifically, the number of times at which the player stops the symbols at the winning combination after transition from the base game to the second game (second game) composed of the stop control game is counted by the counter 85.

On the other hand, if they do not stop in the winning combination, the main CPU 41 decides whether the 1-BET button 26 or the MAX-BET button 27 is pushed (step S39). Then, if the 1-BET button 26 or the MAX-BET button 27 is pushed, it is decided whether the number of execution of the stop control game at the current moment (stored as the variable “n” in the RAM 43) reaches a predetermined number (in this case, ten) or not (step S40). Meanwhile, the predetermined number (in this case, ten) of execution of the stop control game is to be determined and processed in execution of the base game (first game).

If the number of execution of the stop control game does not reach the predetermined number, the main CPU 41 executes changing control process of the symbols in the respective rows without subtraction from the number of the credits by the 1-BET button 26 or the MAX-BET button 27 being pushed. In other words, after the symbols stop, if the BET button 26 or 27 is pushed by the player, the number of credits are not consumed as well as the symbols are scrolled again and the display lamps 83 of the stop switches 82 are lit without operation input of the spin buttons 23.

Next, the value of the variable “n” stored in the RAM 43 is increased by 1 (step S44). At this time, by image-displaying the value of the variable “n” on the upper image display panel 33, phonetically outputting sound correspondent to the number of the variable “n”, or such, the number of reciprocation of the stop control game is reported to the player. After this, the process returns to the step S32.

By processing as such, on the basis of the stop enabling number of times of the symbols to be a winning combination in the second game determined and processed in execution of the base game, the stop control game becomes to be reciprocally executed until the stop enabling number of times.

Meanwhile, in the present embodiment, ten times of the stop control game is set as a time limit for example, however, for example as five minutes, the time limit may be regulated as time.

Further, in the process of the step S40, if the value of the variable “n” is decided to reach a predetermined number (for example, ten), more specifically, if the predetermined number of execution of the stop control game is realized, the main CPU 41 disables operation of the stop switches 82 and terminates the process of the second game (step S41), and payout of a predetermined number of coins correspondent to the number of times at which the winning combination is arranged in which five symbols of crabs stop after execution of a predetermined number of times (ten) of stop control game.

Here, the payout of the coins is determined on the basis of the table shown in FIG. 10 in accordance with the number of times at which the winning combination is arranged in which five symbols of crabs stop. For example, if the number of times at which the winning combination is arranged in which five symbols of crabs stop to be arranged is one, payout of ten coins is executed, if five, payout of 75 coins is executed, and, if the winning combination is arranged for all ten times, payout of 150 coins is executed. Further, if merely N times in ten of stop enabling times the winning combination can be arranged, M coins for the not obtained N times are added as a jack pot value.

Meanwhile, in the process of the step 39, an example in which the main CPU 41 does not consume the number of credits, scrolls the symbols, and executes the next stop control game when the 1-BET button 26 or the MAX-BET button 27 is pushed has been described, however, it may be modified such that credits are consumed when the 1-BET button 26 or the MAX-BET button 27 is pushed, and the consumed number of credits are paid out after each occasion that the symbols stop to terminate the unit game. In this case, by pushing the 1-BET button 26 or the MAX-BET button 27, the apparent number of credits is reduced, however, after termination of the unit game, the number of credits is restored to one before pushing the 1-BET button 26 or the MAX-BET button 27.

Further, in the present embodiment, the winning combination of symbols for the second game is determined in the base game (first game), however, it is not limited thereto and it may be modified that, without determining the winning combination of symbol for the second game, a combination of symbols stopped by operation of the stop switches 82 by the player in the second game is judged and, if the combination of the symbol is a predetermined winning combination, credits are paid out.

FIG. 9 is a drawing showing an example of images displayed in the upper image display panel 33 and the lower image display panel 16 at a time of execution of the stop control game. On the lower image display panel 16, an image 95 showing an arrow pointing the display window 15 or upward and “Look Up” is displayed, and, on the upper image display panel 33 as a display device, an image 92 showing decision of the second game is displayed. The image 95 is an image prompting the player to see the upper image display panel 33.

On the upper image display panel 33, letters of “SECOND GAME DECIDED!! PUSH THE BUTTON AND STOP THE SYMBOL TO ARRANGE CRABS ON THE WINNING LINE!” are under display. Also thereby, the player may be surely informed of transition from the base game to the second game (second game) composed of the stop control game and the winning combination in the second game by viewing this display and recognize that he can stop the respective symbols under scroll by pushing the stop switches 82.

As such, in the slot machine and the method of playing in accordance with the present embodiment, if a combination of symbols stopping in the base game is a predetermined combination, transition to the second game of a predetermined number of times is executed and the winning combination in the second game is displayed by the display device. Further, in the second game, the player stop the symbols by pushing the stop switch and payout of an award in accordance with the number of times at which the winning combination of the symbols stop on the winning line L is executed.

In other words, in the slot machine and the method of playing in accordance with the present embodiment, if the combination of the symbols stopping in the base game becomes the specific combination and control input signals from the external are received to transit to the stop control game of a predetermined number of times, the player is allowed to stop symbols at the winning combination by pushing the stop switch, and, as a result of it, an award correspondent to the number of times at which the winning combination stops on the winning line is paid out.

Therefore, it surely makes the player have expectation of transition to the new stop control game, and prevents the player from losing interest and concern for the game since an award is determined by the treatment of stopping the symbols by the player.

Further, it makes it possible to provide a new state of the game in that the player himself pushes the stop switches 82 to stop the reel symbols under scroll so as to realize a winning combination, thereby it prevents the player from losing interest and concern for the game.

Although the embodiment of the slot machine in accordance with the present invention has been described above, it's nothing but an illustration of a concrete example and does not limit the present invention, and concrete constitutions of the respective means may be properly modified in design. Further, the described effects with respect to the embodiment of the present invention are nothing but listed effects most preferably occurred from the present invention, and the effects by the present invention are not limited to what are described in the embodiment of the present invention.

What is claimed is:

1. A slot machine comprising:
a controller operable to receive a control input signal from an external to cause transition to a second game of a predetermined number of times, in which re-arrangement of a plurality of symbols is enabled, and to regulate payout to vary depending on a number of times for which a result of re-arranging the symbols by the control input signal corresponds with a specific combination of symbols for the second game, if a combination of symbols re-arranged in a first game is a specific combination as a result of re-arranging the symbols arranged on the display.

2. The slot machine of claim 1, wherein the controller displays the specific combination of symbols for the second game if transition to the second game is executed.

3. The slot machine of claim 1, further comprising a storage device storing a correspondence relation in which the payout increases as the number of times for which the result of re-arranging the symbols by the control input signal corresponds with the specific combination of symbols for the second game.

4. The slot machine of claim 3, wherein the controller determines the specific combination of symbols for the second game in the first game.

5. A slot machine comprising:
a controller operable to re-arrange a plurality of symbols arranged on a display in a first game, wherein the controller transits from a first game in which re-arrangement of the symbols is automatically completed to a second game of a predetermined number of times, in which re-arrangement of a plurality of symbols is enabled by receiving a control input signal from an external, displays a specific combination of symbols for the second game, and regulates payout to vary depending on a number of times for which a result of re-arranging the symbols by the control input signal corresponds with the specific combination of symbols for the second game.

6. The slot machine of claim 5, further comprising a storage device storing a correspondence relation in which the payout increases as the number of times for which the result of re-arranging the symbols by the control input signal corresponds with the specific combination of symbols for the second game.

7. The slot machine of claim 6, wherein the controller determines the specific combination of symbols for the second game in the first game.

8. A slot machine comprising:
a display operable to arrange a symbol matrix formed of a plurality of columns and a plurality of rows;
a first controller operable to execute a first game to select and determine symbols from a plurality of symbols to be arranged in the symbol matrix and automatically stop the determined symbols from a scroll state so as to re-arrange the symbols as a new symbol matrix;
a second controller operable to execute a second game of a predetermined number of times to enable a stop switch operable by a player, cause to display enablement of the stop switch, stop scroll to re-arrange the symbol matrix on the display in relation to timing of input by the player, and regulate payout to vary depending on a number of times for which a result of re-arranging the symbols by the control input signal corresponds with a specific combination of symbols for the second game, if a combination of symbols arranged on a payline set with respect to the symbol matrix re-arranged by the first controller in the first game is a specific combination; and
a display device operable to display the specific combination for the second game by a display control of the second control, if the re-arranged combination of the symbols in the first game is a predetermined combination of symbols.

9. The slot machine of claim 8, further comprising a storage device storing a correspondence relation in which the payout increases as the number of times for which the result of re-arranging the symbols by the control input signal corresponds with the specific combination of symbols for the second game.

10. The slot machine of claim 8, wherein the controller determines the specific combination of symbols for the second game in the first game.

11. A playing method of a slot machine, comprising:
reciprocating a unit game to re-arrange a plurality of symbols to be a combination of symbols determined by a controller from a state of arranging the plurality of symbols on a display, wherein, if the combination of the symbols determined by the controller in a first game to automatically re-arrange the symbols is a predetermined combination, transition to the second game of a predetermined number of times to re-arrange the symbols by operation of the player is executed, and it is enabled to vary payout depending on a number of times for which a result of re-arranging the symbols by operation of the player corresponds with a specific combination of symbols for the second game.

12. The playing method executed in the slot machine of claim 11, wherein the slot machine comprises a storage device storing a correspondence relation in which the payout increases as the number of times for which the result of re-arranging the symbols by the control input signal corresponds with the specific combination of symbols for the second game.

13. A playing method executed in a slot machine, comprising steps of:
re-arranging a plurality of symbols on a display, wherein, if a plurality of symbols arranged on the display is re-arranged, prior to re-arrangement, the controller determines a plurality of symbols for the re-arrangement and re-arranges the plurality of symbols on the display;
enabling a stop switch linked with the controller and enabling to re-arrange the plurality of symbols for a predetermined number of times by input of the stop switch independently of control of the controller, if the plurality of the symbols re-arranged are a predetermined combination; and
variating payout to the player depending on a number of times for which the specific combination of the symbols is re-arranged by input of the stop switch.

14. The playing method executed in the slot machine of claim 13, wherein the slot machine comprises a storage device storing a correspondence relation in which the payout increases as the number of times for which the result of re-arranging the symbols by the control input signal corresponds with the specific combination of symbols for the second game.

15. A playing method executed in a slot machine, comprising:
reciprocating a unit game in which a game starts by scrolling a plurality of symbols on a display under control of a controller and the game is terminated by being stopped and arranged at a combination of symbols determined by the controller;
a first step to make symbols be in a control state capable of re-arranging the symbols for a predetermined number of times, the symbols scrolling on the display on the basis of an input signal from the stop button switch linked with the controller, if symbols to be a predetermined combination are arranged on the display;
a second step to judge whether a combination of the symbols re-arranged on the basis of the input signal from the stop button switch becomes a specific combination of symbols in the control state; and
a third step to regulate payout depending on a number of times for which a result of judging in the second step is judged to be the specific combination.
